(19) United States
(12) Patent Application Publication
(10) Pub. No.: US 2013/0235935 A1
(43) Pub. Date: Sep. 12, 2013

(54) PREPROCESSING METHOD BEFORE IMAGE COMPRESSION, ADAPTIVE MOTION ESTIMATION FOR IMPROVEMENT OF IMAGE COMPRESSION RATE, AND METHOD OF PROVIDING IMAGE DATA FOR EACH IMAGE TYPE

(71) Applicants: Hyun Chul KANG, Daejeon (KR); Eunjin KO, Daejeon (KR); Noh-Sam PARK, Daejeon (KR); Sangwook PARK, Gyeryong-si (KR); Mi Kyong HAN, Daejeon (KR); Jong Hyun JANG, Daejeon (KR); Kwang Roh PARK, Daejeon (KR)

(72) Inventors: Hyun Chul KANG, Daejeon (KR); Eunjin KO, Daejeon (KR); Noh-Sam PARK, Daejeon (KR); Sangwook PARK, Gyeryong-si (KR); Mi Kyong HAN, Daejeon (KR); Jong Hyun JANG, Daejeon (KR); Kwang Roh PARK, Daejeon (KR)

(73) Assignee: Electronics and Telecommunications Research Institute, Daejeon (KR)

(21) Appl. No.: 13/555,658

(22) Filed: Jul. 23, 2012

(30) Foreign Application Priority Data
Mar. 9, 2012 (KR) 10-2012-0024538

(51) Int. Cl. H04N 7/32

(52) U.S. Cl. 375/240.16; 375/E07.243

(57) ABSTRACT

The present invention relates to an image compression pre-processing method before image compression, including extracting a plurality of sample frames from an image; calculating a minimum value of the sum of errors between each of blocks included in a random present sample frame of the sample frames and each of blocks corresponding to a reference sample frames; generating an object for each region based on a distribution of the calculated minimum values of the sums of errors for each block; calculating a motion reference value by tracking the motion of the object in the plurality of sample frames; and determining an image type of the image by comparing the motion reference value with a threshold.

### CROSS-REFERENCES TO RELATED APPLICATIONS

The present application claims priority under 35 U.S.C 119(a) to Korean Application No. 10-2012-0024538, filed on Mar. 9, 2012, in the Korean Intellectual Property Office, which is incorporated herein by reference in its entirety set forth in full.

### BACKGROUND

Exemplary embodiments of the present invention relate to a pre-processing method before image compression, an adaptive motion estimation method for an improved image compression rate, and a method of providing image data for each image type, and more particularly, to a pre-processing method for enabling more efficient image compression to be performed according to an image type of an image to be compressed, an adaptive motion estimation method of improving an image compression rate by adaptively controlling a block size and the number of partitions according to an image type of an image, and a method of providing image data for each image type for selecting a proper image type according to a network bandwidth through which an image is provided and transmitting an image relevant to the selected image type.

The background technology of the present invention is disclosed in Korean Patent Publication No. 2007-0076672 (disclosed on Jul. 25, 2007).

In order to transfer digital video from a source (e.g., a camera or stored video) to a destination (e.g., a displayer), core processes, such as compression (encoding) and restoration (decoding), are necessary. ‘Original’ digital video, that is, a load of a bandwidth is compressed into a size that is easy to handle for transmission or storage and then restored again for display through the processes.

For the compression and restoration processes, an international standard ISO/IEC 13818 called MPEG-2 was established for the digital video industry, such as digital TV broadcasting and DVD-video, and two compression standards developed for an expected demand for an excellent compression tool are MPEG-4

Visual and H.264. The H.264 standard is a video compression technology standard established by International Telecommunications Union Telecommunication Standardization Sector (ITU-T) and also called Moving Picture Experts Group—Phase 4 Advanced Video Coding (MPEG-4 AVC). The two compression standards experience the same creation process and have some common characteristics, but have different objects.

The object of MPEG-4 Visual provides a free and flexible structure for video communication by overcoming a limit dependent on a rectangular video image and thus enables the best function, such as efficient video compression and object-based processing, to be used. In contrast, H.264 has a more practical object, and the object of H.264 is to support application fields, such as broadcasting, storage, and streaming which are widely spread in the market by performing rectangular video compression, such as in the previous standards, more efficiently, powerfully, and practically.

Like a conventional motion image encoding method, the H.264 standard is based on motion estimation DCT technology for producing a prediction signal whose motion has been estimated from an already encoded image frame and encoding a difference signal (or a residual signal) between the image frame and the prediction signal through Discrete Cosine Transform (hereinafter referred to as DCT). The H.264 standard has an excellent compression rate which is 2 to 3 times higher than that of the existing MPEG2. For example, if the H.264 standard is applied to Standard Definition (SD) level service having 4 Mega bit per second (Mbps), 1.5 Mbps is sufficient for MPEG2. The H.264 standard may provide high-quality video of a DVD level at a rate of 1 Mbps or lower, and thus satellite, cable, and Internet Protocol TV (IPTV) also have an increasing interest in the H.264 standard.

Meanwhile, with the advent of a mobile smart era, there is an increasing demand for various image services of high picture quality even in mobile terminals. Thus, in order to solve a brown-out phenomenon according to increased network traffic, there is an urgent need for a compression processing scheme from a viewpoint of media. Furthermore, active research is being carried out on image media compression technology which may support the execution of core technology for not only 3-D, hologram, and an image of 4K higher than HD level, but also an image of high picture quality, that is, an image of 8K.

A variety of image processing algorithms are used in order to search for an optimal Peak Signal-to-Noise Ratio (PSNR) and an optimal compression rate in performing image compression. From among the algorithms, a Motion Estimation (ME) algorithm is a method of increasing a PSNR value, but focus is given on the improvement of the speed of the ME algorithm owing to complexity and a high computational load according to a used algorithm.

Furthermore, in order to improve a compression rate and a PSNR suitable for a specific image, a process of setting various block sizes and performing partition (i.e., a task of partitioning a block within a frame) is performed. In the prior art, in order to search for a proper block size and a proper number of partitions, numerous feedback processes are performed by not sufficiently taking the PSNR and the compression rate into consideration. Accordingly, there are lots of problems in resource management in the transmission of an image, such as an excessive network traffic load.

### SUMMARY

An embodiment of the present invention relates to a pre-processing method for enabling more efficient image compression to be performed according to an image type of an image to be compressed.

Another embodiment of the present invention relates to an adaptive motion estimation method of improving an image compression rate by adaptively controlling a block size and the number of partitions according to an image type of an image.

Yet another embodiment of the present invention relates to a method of providing image data for each image type for selecting a proper image type according to a network bandwidth through which an image is provided and transmitting an image relevant to the selected image type.

In one embodiment, the present invention provides an image compression pre-processing method before image compression, including extracting a plurality of sample frames from an image; calculating a minimum value of sum of errors between each of blocks included in a random present sample frame of the sample frames and each of corresponding blocks of a reference sample frame; generating an object for each region based on a distribution of the calculated minimum values of the sums of errors for each block; calculating a motion reference value by tracking the motion of the object in the plurality of sample frames; and determining an image type of the image by comparing the motion reference value with a threshold.

In the present invention, the image compression pre-processing method preferably further includes setting a block size and a number of partitions for a plurality of frames included in the image based on the determined image type.

In the present invention, in the setting of the block size and the number of partitions, the block size and the number of partitions preferably are set for each object within a frame or the block size and the number of partitions are set for all the frames.

In the present invention, the image compression pre-processing method preferably further includes additionally setting the candidate list of a block size and the number of partitions for a plurality of frames included in the image.

In the present invention, the image compression pre-processing method preferably further includes reading the critical sum of errors for determining the image type and preliminarily determining an image type of the image by comparing the minimum value of the sum of errors, calculated from the random present sample frames, with the critical sum of errors.

In the present invention, the sum of errors preferably is a Sum of Square Errors (SSE) or a Sum of Absolute Errors (SAE) between pixel values at respective positions within each of the blocks of the present sample frame and pixel values at corresponding positions within a corresponding block of the reference sample frame.

In another embodiment, the present invention provides an adaptive motion estimation method for an improved image compression rate, including performing intra-prediction on a relevant frame if the relevant frame is an I-frame; reading a block size and the number of partitions of blocks within a frame according to a previously stored image type; performing a partition task on the frame; calculating the sum of errors between each of the blocks of the frame and each of blocks of a reference frame within a relevant search range; extracting a prediction block and a motion vector; sequentially and repeatedly performing motion compensation based on each relevant block, while gradually increasing a relevant sum of errors starting from a block having a minimum sum of errors; calculating an image compression rate of the frame; determining whether the calculated image compression rate satisfies the threshold of a compression rate; and if, as a result of the determination, the image compression rate is determined to satisfy the threshold of the compression rate, storing an image type of the relevant frame.

In the present invention, sequentially and repeatedly performing the motion compensation on the relevant block preferably is repeatedly performed until the Peak Signal-to-Noise Ratio (PSNR) of the relevant frame satisfies a preset value or until the preset number of times is reached.

In the present invention, the adaptive motion estimation method preferably further includes reading a block size and a number of partitions of blocks within a frame defined in a pre-stored candidate list and returning to the performing the partition task on the frame, if, as a result of the determination, the image compression rate is determined not to satisfy the threshold of the compression rate.

In the present invention, the adaptive motion estimation method preferably further includes newly reading a block size and the number of partitions of blocks within a frame, changed according to user selection even though the image compression rate is determined to satisfy the threshold of the compression rate as a result of the determination, and returning to the performing the partition task on the frame.

In the present invention, the sum of errors is a Sum of Square Errors (SSE) or a Sum of Absolute Errors (SAE) between pixel values at respective positions within each of the blocks of the frame and pixel values at corresponding positions within a corresponding block of the reference frame.

In yet another embodiment, the present invention provides a method of providing image data for each image type, including calculating a network bandwidth provided to a client terminal; primarily determining whether the network bandwidth exceeds a lower threshold; if, as a result of the primary determination, the network bandwidth is determined to exceed the lower threshold, secondarily determining whether the network bandwidth exceeds a higher threshold; if, as a result of the secondary determination, the network bandwidth is determined to exceed the higher threshold, thirdly determining whether the network bandwidth exceeds a preset highest threshold; if, as a result of the third determination, the network bandwidth is determined to exceed the highest threshold, selecting a first image type having a highest compression rate; and transmitting a frame related to a selected image type.

In the present invention, the method preferably further includes selecting a second image type having a higher PSNR, if, as a result of the primary determination, the network bandwidth is determined not to exceed the lower threshold.

In the present invention, the method preferably further includes selecting a third image type having a compression rate lower than the first image type, but higher than the second image type, if, as a result of the secondary determination, the network bandwidth is determined not to exceed the higher threshold or if, as a result of the third determination, the network bandwidth is determined not to exceed the highest threshold.

### BRIEF DESCRIPTION OF THE DRAWINGS

The above and other aspects, features and other advantages will be more clearly understood from the following detailed description taken in conjunction with the accompanying drawings, in which:

FIG. 1 shows an image sequence configuration at the time of image compression;

FIG. 2 shows a common image compression encoding flowchart;

FIG. 3 shows the construction of a system for performing adaptive motion estimation processing according to an embodiment of the present invention;

FIG. 4 is a flowchart illustrating a pre-processing method before image compression according to an embodiment of the present invention;

FIGS. 5a and 5b are flowcharts illustrating an adaptive motion estimation method for an improved image compression rate according to an embodiment of the present invention;

FIG. 6 is a flowchart illustrating a method of providing image data for each image type according to an embodiment of the present invention; and

FIG. 7 shows the structure of a block having a fixed or variable block size.

### DESCRIPTION OF SPECIFIC EMBODIMENTS

Hereinafter, embodiments of the present invention will be described with reference to accompanying drawings. However, the embodiments are for illustrative purposes only and are not intended to limit the scope of the invention.

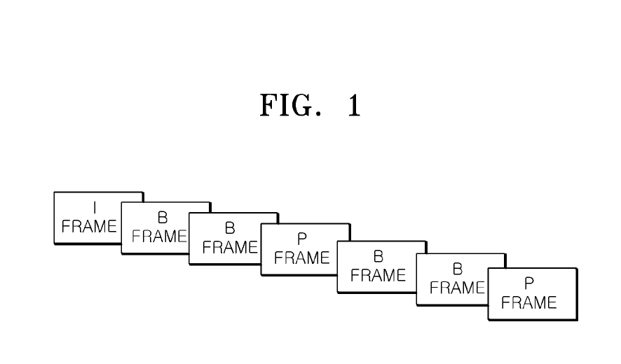

FIG. 1 shows an image sequence configuration at the time of image compression. An image consists of a total of three types of frames, that is, an Intra (I) frame, P frames, and B frames. The I frame is an independent frame which may be independently decoded without reference to other images. The P frame means prediction between frames, and it may be constructed with reference to a previous I frame and a previous P frame. Furthermore, the B frame is a frame that refers both a previous reference frame and a next frame.

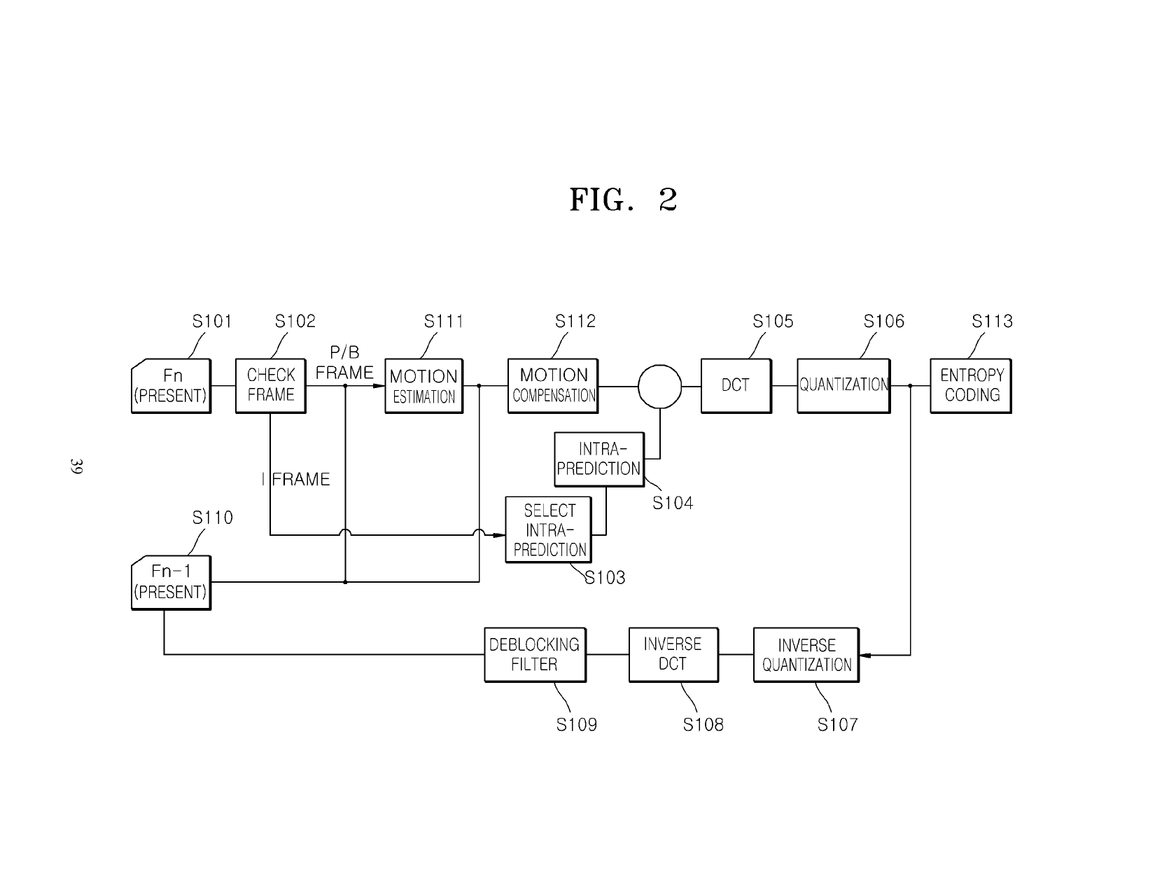

FIG. 2 shows a common image compression encoding flowchart. A common image compression encoding process is described below with reference to FIG. 2. Image compression is performed in order shown in FIG. 2.

First, the present frame Fn is read (S101). The frame Fn received at the time of image compression is processed for each macro block. Each macro block may be encoded by intra-prediction and inter-prediction. Intra-prediction is a process of reducing spatial redundancy within an I frame, and inter-prediction is performed based on a motion compensation and motion compensation concept in order to remove redundancy between consecutive frames.

At the start of image compression, the present frame Fn becomes an I frame. When image compression is already started, the present frame Fn may become a P frame or a B frame. A frame type of the read frame is checked because the read frame is differently processed according to a frame type (S102).

If the frame type is an I frame, each macro block of the I frame is partitioned in a 4*4 size of 16*16 or less for intra-prediction. Next, applicable intra-prediction is selected (S103), and the selected intra-prediction is applied (S104).

Next, compression is performed on the I frame through Discrete Cosine Transform (DCT) (S105), quantization (S106), and entropy coding (S113) in order to improve compression efficiency. Compression for the I frame is finished as described above. In order to make the I frame the reference frame of a next frame, the I frame is made into a reference frame Fn−1 (S110) through processes, such as inverse quantization (S107), inverse DCT (S108), and deblocking filtering (S109).

Next, when a next frame is received, a frame type of the next frame is checked. If a frame type of the next frame is a P or B frame, the next frame is compared with the reference frame, and motion estimation (S111) and motion compensation (S112) are performed on the next frame. As in the processing of the I frame, compression is performed on the next frame through DCT (S105), quantization (S106), and entropy coding (S113).

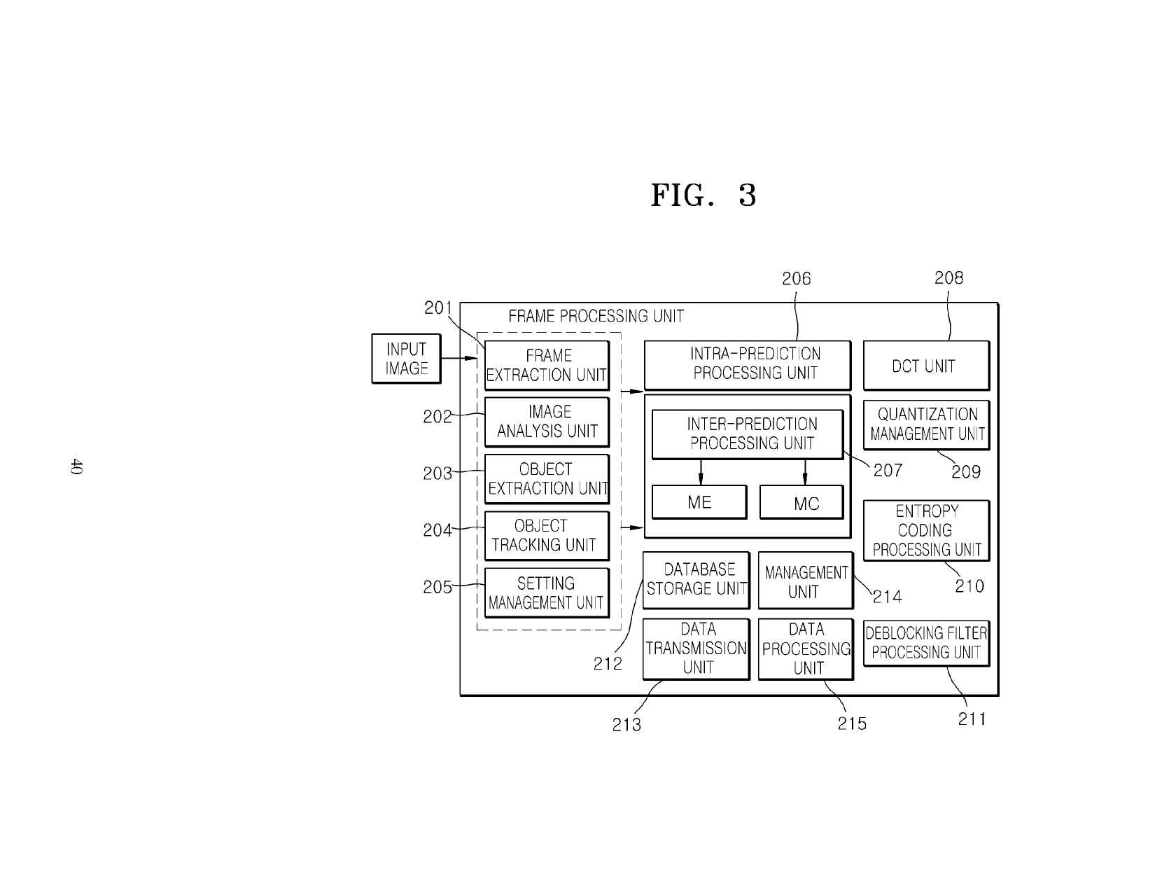

FIG. 3 shows the construction of a system for performing adaptive motion estimation processing according to an embodiment of the present invention. The function of each of the elements of the system is described in short below with reference to FIG. 3.

A frame extraction unit 201 is responsible for extracting frames from an input image. A type of the image data is checked, the image data is transformed into a frame for image compression, and frames may be extracted from the image data in order to distinguish an I frame or P/B frames from one another or random frames may be extracted from the image data according to user setting.

An image analysis unit 202 is responsible for a kernel function of determining an image type, a block size, the number of partitions of each of the frames of the input image, a compression rate, a Peak Signal-to-Noise Ratio (PSNR) value, etc. by analyzing the input image. An object extraction unit 203 may define an object in the input image and extract the object for distinguishing regions from one another. An object tracking unit 204 functions to track the object of past and future frames on the basis of the present frame. A setting management unit 205 functions to manage parameters set in all the elements of the present system for adaptive motion estimation processing. For example, the setting management unit 205 is responsible for managing lots of parameters, such as an image type, a macro block size for image compression, a QP size (quantization), a reference block search range, the number of received frames, object information, background information, a reference PSNR value, a threshold of the compression rate, the number of sample frames, a sample frame time interval, and a partition initial value.

An intra-prediction processing unit 206 is responsible for processing a process of reducing spatial redundancy for the I frame of an image.

An inter-prediction processing unit 207 performs motion estimation (ME) and motion compensation (MC) processes as representative processes in order to reduce redundancy between consecutive frames. A basic concept of motion estimation lies in a process of searching the region of a reference frame (a past or future frame, that is, a frame previously encoded and transmitted) in order to search for a sample region matching with A*B blocks within the present frame and of searching for the best matching region by comparing the A*B blocks of the present frame with the relevant A*B blocks of the search region all or partially. A retrieved candidate region becomes a prediction block for the present A*B blocks, and A*B error blocks are produced by subtracting the prediction block from the present block. This process is called motion compensation.

A database storage unit 212 performs a function of storing all data generated in the present processing system. A DCT unit 208 performs mathematical processing, and it is responsible for a function of transforming an expression of a pixel region into an expression of a frequency region.

The DCT result of motion compensation prediction errors is represented by a DCT coefficient value indicating a frequency component. A quantization management unit 209 manages a process of approximating the DCT coefficient value based on a discrete representative value. An entropy coding processing unit 210 is responsible for a function of storing consecutive symbols indicating the elements of an image or transforming the elements of an image into compressed bit streams that may be easily stored. A deblocking filter processing unit 211 is responsible for a function of reducing the distortion of a block which occurs when an image is encoded.

A data transmission unit 213 performs a function of transmitting data according to a network bandwidth. A resource management unit 214 performs a network resource management function by calculating a network bandwidth and flexibly transmitting image data according to an image type which is managed according to an available network state.

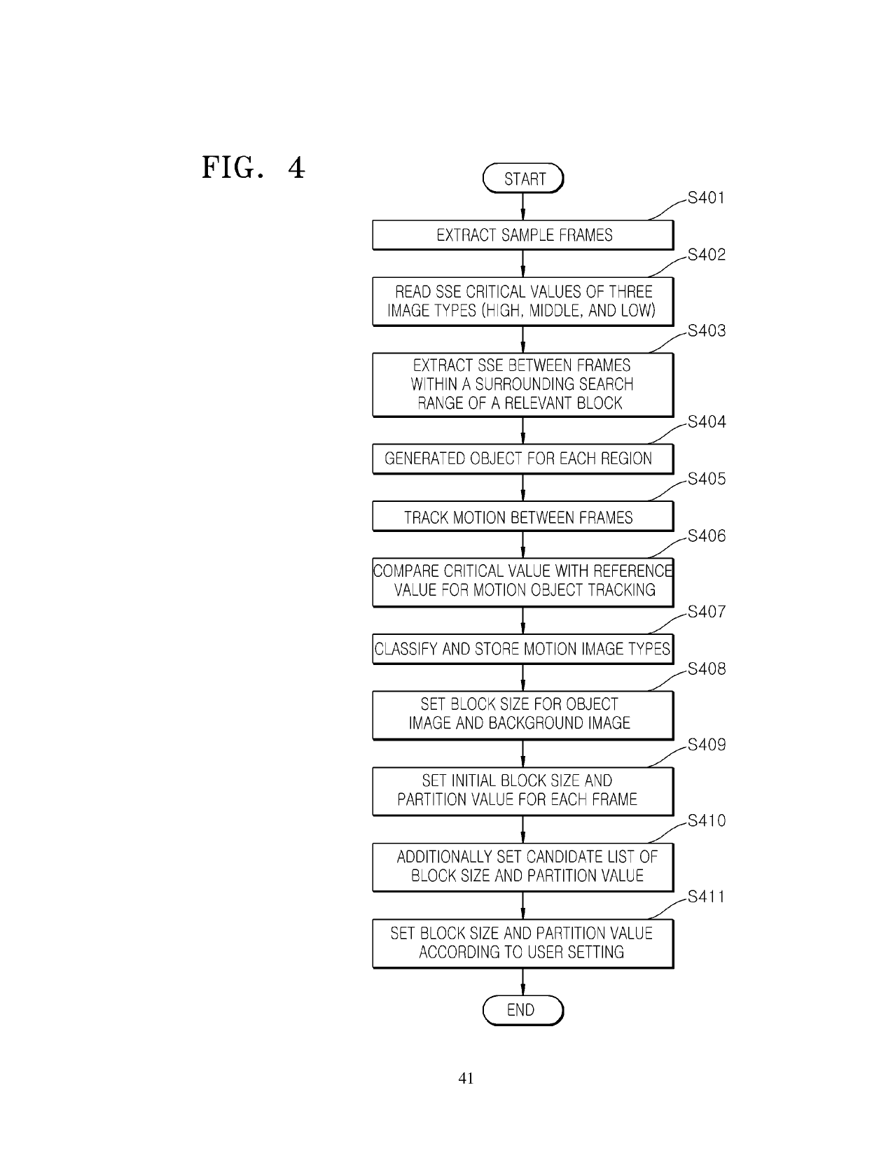

FIG. 4 is a flowchart illustrating a pre-processing method before image compression according to an embodiment of the present invention. More particularly, the flowchart of FIG. 4 is an internal processing flowchart which is related to the extraction of the samples of image data before image compression and the setting of an image type and the initial values of a block size and the number of partitions. The pre-processing method before image compression according to the present embodiment is described below with reference to FIGS. 3 and 4.

First, the frame extraction unit 201 extracts a plurality of sample frames from a specific image for image compression according to user setting (S401). Here, P or the B frames may be extracted as the sample frames. For example, if an image having 30,000 frames exists, sample frames may be randomly extracted from the image according to user setting. Assuming that a user consecutively extracts a total of 300 frames (i.e., 30 frames in each time zone ten times) from the output image of 30,000 frames as the sample frames, a basic frame having the greatest image error between the present frame and a previous frame, from among the 300 frames, may be extracted, and reference frames before and after the basic frame may be extracted. Furthermore, a frame having the greatest image error, from among all the frames, may be extracted according to a setting option.

Next, the setting management unit 205 reads a critical sum of errors, set for each image type, from the database storage unit 212 in order to determine an image type (S402). Here, the sum of errors may be a Sum of Square Error (SSE) or a Sum of Absolute Error (SAE) between a pixel value in each position within each block of the present sample frame and a pixel value in a relevant position within the relevant block of a reference sample frame. That is, the setting management unit 205 reads information about the threshold of an SSE or the threshold of an SAE for determining three image types (e.g., high, middle, and low), which are stored in the database storage unit 211. For reference, equations for calculating the SSE and the SAE are shown in Equations 1 and 2 below. To search for a value at which the SSE or SAE is a minimum may be called a process of searching for the most matching part within a search region between the block of the present frame and a reference frame.

E(a,b)=Σ_{(x,y)εBlock b}[I_{c}(x,y)−I_{R}(x+a,y+b)]² [Equation 1]

E(a,b)=Σ_{(x,y)εBlock b}[I_{c}(x,y)−I_{R}(x+a,y+b)] [Equation 2]

(In Equations 1 and 2, I_{c}(x,y) is a pixel value at the position (x,y) of the present frame, Iᵣ(x,y) is a pixel value at the position (x,y) of the reference frame, a and b are motion vector values, and Block b is a block number)

Information about the threshold of the sum of errors may be inputted by a user, and the threshold may be flexibly set according to an image type. Furthermore, the three image types may be, for example, ‘high’, ‘middle’, and ‘low’. An image having a lot of motion in an object, such as a sports image or an action movie, may be set as ‘high’, an image having middle motion in an object, such as a documentary or an introduction image at an exhibition hall, may be set as ‘middle’, and an image having almost no motion in an object, such as a video conference or a conference call, may be set as ‘low’. Furthermore, the ‘high’ type may be subdivided into lower classes, for example, ‘high-1’, ‘high-2’, and ‘high-3’ according to user setting. The values may be applied to a candidate list later.

Furthermore, regarding the three image types, a user may set initial values of a block sizes and of the number of partitions that form the block of an image. This task is for searching for an optimal block size and an optimal number of partitions according to various image types. The block size is 16*16 blocks or more which is provided in the H.264 standard, and various combinations of block sizes, such as 64*64, 128*128, 256*256, and 256*64, may be set by a user in order to improve the compression rate.

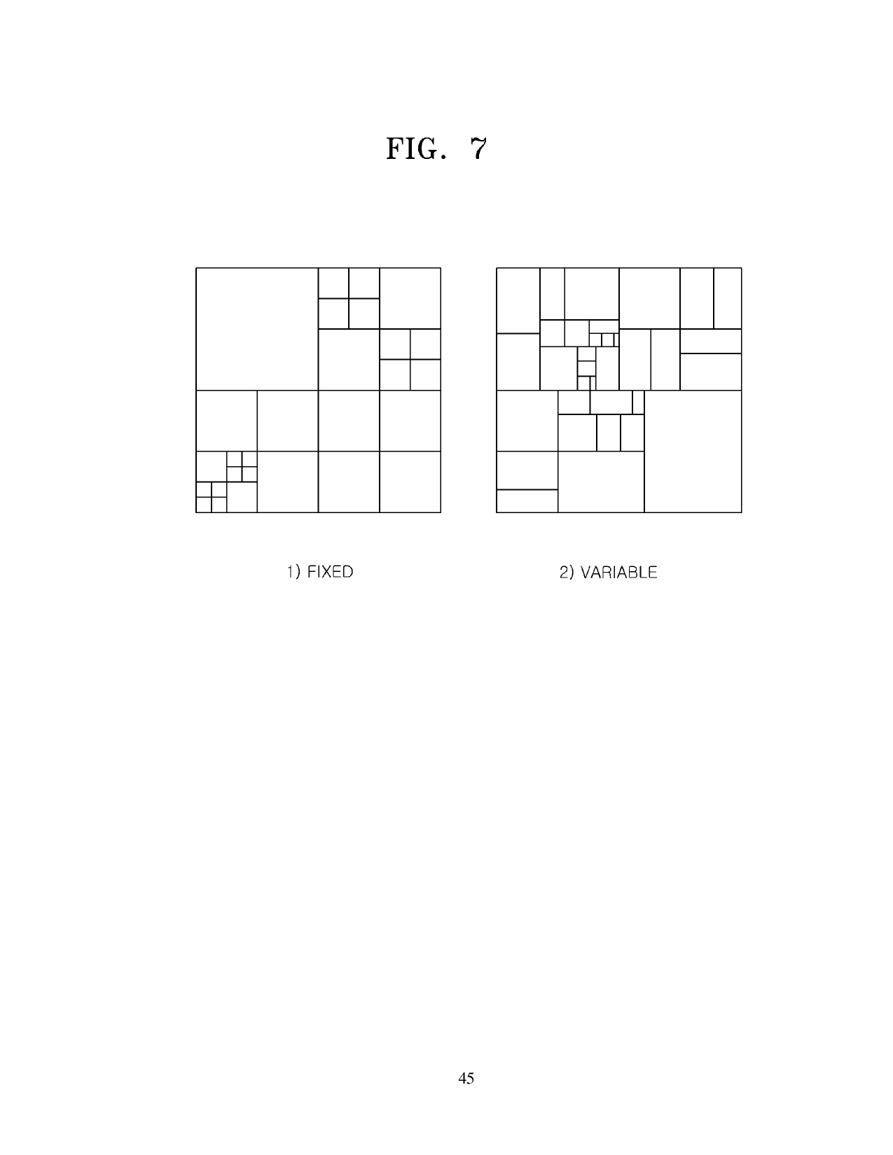

Next, the inter-prediction processing unit 207 (ME) calculates a minimum value of the sum of errors between each of blocks, included in the present sample frame of the sample frames, and each of blocks corresponding to the reference sample frames (S403). That is, a minimum sum of errors is calculated in a search range near a specific block of the present frame and a relevant block between the past and future frames. This task may be chiefly performed using a Fixed-Size Block Matching (FSBM) method or a Variable-Size Block Matching (VSBM) method. Here, block matching is used to estimate motion between the present frame and the reference frame. The FSBM method is a method of performing matching for blocks by partitioning the present frame in a block size (in general, a 16×16 block size) having a number of fixed quadrangles (see a left figure in FIG. 7). The VSBM method is a method of partitioning the present frame into variable blocks having a random size (see a right figure in FIG. 7).

Next, the object extraction unit 203 generates an object for each region on the basis of a distribution of minimum values of the sum of errors for each of the calculated blocks (S404). That is, the object extraction unit 203 primarily determines whether an image has an image type having a lot of motion by comparing previously stored threshold information with the extracted sum of errors. A distribution of the sums of errors within the extracted image is generated for each region. The region generated as described above may be defined as an object.

Next, the object tracking unit 204 calculates a motion reference value by tracking the motion of the object in the plurality of sample frames (S405). When an object is detected, how the object has moved may be determined by partitioning the object. Here, a reference value for the tracking may be set by a user, and how the tracking will be performed using what method is different according to a setting method. The motion reference value for the tracking means a minimum reference value indicating that the object has moved. An object extraction value used in an object extracting algorithm which may be set by a user may become a reference value according to definition. Meanwhile, the object tracking method includes several methods; i) a method of extracting a contour line and tracking the contour line while dynamically updating the contour line, ii) a method of separating an object and a background from each other, producing a binary object and background, extracting the center of a target, and detecting information about the motion of the target based on a change in the center of the target, iii) a method of extracting information about a pixel itself or the characteristic of an object and searching for similarity while moving a search region, and iv) a method of defining a model with high accuracy and restoring a track.

Next, whether the motion reference value for tracking the motion object has exceeded a threshold is determined by comparing the motion reference value with the threshold (S406). If, as a result of the determination, the motion reference value is determined to have exceeded the threshold, the image may be considered as an image a lot of motion. If, as a result of the determination, the motion reference value is determined not to have exceeded the threshold, the image may be considered as an image having relatively small motion.

Next, a motion image type is determined based on the reference value and then stored in the database storage unit 212 (S407).

Furthermore, the image analysis unit 202 sets a block size and the number of partitions for an image of the object and an image of the background (S408). Here, a block size and the number of partitions may also be set for all the frames of the image. That is, when setting the block size and the number of partitions, the block size and the number of partitions may be set for each object within a frame or the block size and the number of partitions may be set for all the frames. One of the two methods having an improved compression rate may be selected.

Next, the image analysis unit 202 initially sets a block size and the number of partitions for a plurality of the frames included in the image based on the determined image type (S409).

Furthermore, the image analysis unit 202 may additionally set a candidate list for the block size and the number of partitions for the plurality of frames included in the image (S410). In general, if image motion is great, a large block size is not suitable because it is disadvantageous for the compression rate or the PSNR. In case of an image having almost no motion, a large block size is advantages for the compression rate or the PSNR. Likewise, as the number of partitions increases, the PSNR becomes better, but the compression rate becomes poor. If the number of partitions is too small, the PSNR or the compression rate may not be good. This is because the block size or the number of partitions has a great effect on the PSNR and the compression rate according to an image. For this reason, the candidate list of block sizes and partition values which are related to a next candidate are additionally set according to an image type in addition to the initial values.

Furthermore, the image analysis unit 202 may set the block size and the number of partitions according to user setting (S411). Furthermore, the image analysis unit 202 analyzes various images in order to search for an optimal block size and partition value and manages an accumulation value of the block sizes and the partition values for each image data type.

As described above, in accordance with the present embodiment, sample frames may be extracted from an image, the sample frames may be classified according to the motion image types, and initial values and candidate values of an optimal block size and the number of partitions suitable for the image may be previously set based on the initial values and the candidate values.

Accordingly, when image compression is actually performed, image compression can be performed more efficiently according to an image type.

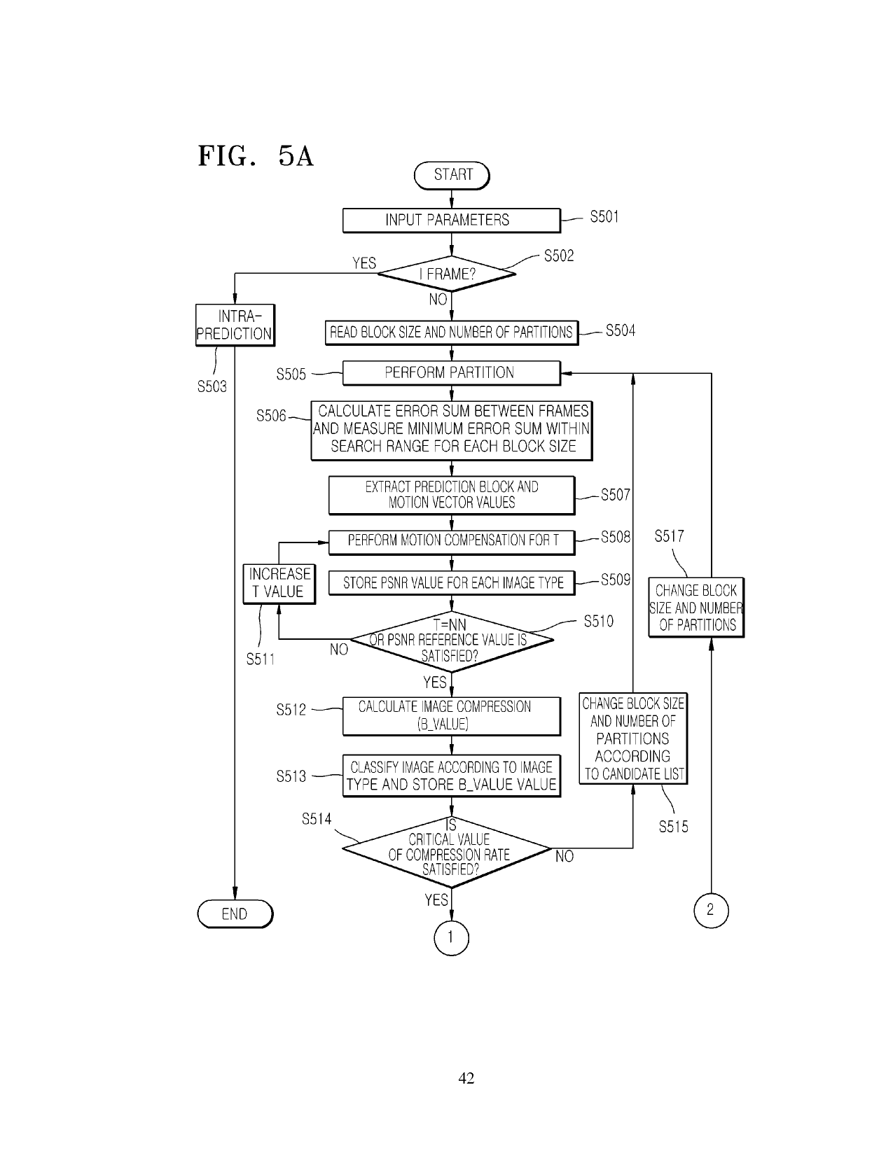

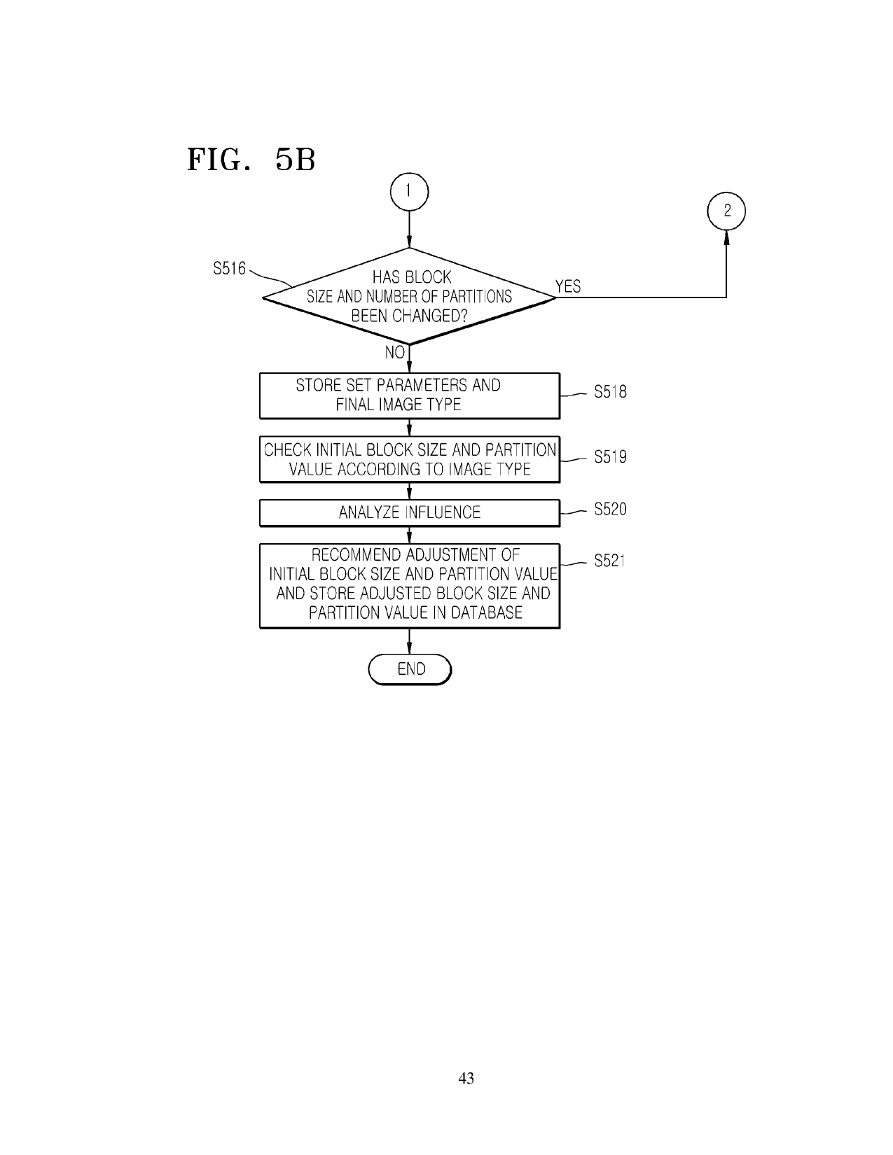

FIGS. 5a and 5b are flowcharts illustrating an adaptive motion estimation method for an improved image compression rate according to an embodiment of the present invention. The adaptive motion estimation method according to the present embodiment is described below with reference to FIGS. 5a and 5b.

First, the setting management unit 205 sets basic initial parameters inputted by a user, such as a macro block size for image compression, a QP size (quantization), a reference block search range, the number of input frames, an image type, object information, background information, a reference PSNR value, and a threshold of a compression rate (S501). Furthermore, the setting management unit 205 sets and manages a reference PSNR and a threshold of a compression rate. Since the compression rate may be flexibly managed according to the reference PSNR, a user may set the reference PSNR in the level that subjective picture quality measurement is not difficult. The reference PSNR value may be stored in, for example, a P_HIGH parameter. Furthermore, the threshold of the compression rate that may be set by a user may be stored in, for example, a B_HIGH parameter.

Next, the intra-prediction processing unit 206 determines whether the input frame is an I frame or not (S502). If, as a result of the determination, the input frame is an I frame, the intra-prediction processing unit 206 performs intra-prediction (S503), and this process is completed. If, as a result of the determination, the input frame is not an I frame, but a B or P frame, however, the intra-prediction processing unit 206 performs the following inter-prediction mode.

The setting management unit 205 reads the block size and the number of partitions of each of blocks within a frame according to a previously stored image type (S504). That is, the setting management unit 205 reads the block size of each block and the number of partitions to partition the block within the frame according to an image type stored in the database storage unit 212.

Next, the inter-prediction processing unit 207 (ME) performs a partition task on the frame (S505). That is, the inter-prediction processing unit 207 performs the partition task on each image in order to partition blocks that form a frame and also performs a block matching task.

Furthermore, the inter-prediction processing unit 207 calculates the sums of errors between the blocks of a relevant frame and a reference frame within a relevant search range for each block (S506). Here, the FSBM and VSBM methods may be separately applied to object information or background information for each image frame, or the FSBM and VSBM methods may be applied to the entire image frame screen. The image frame may be partitioned in block sizes of various forms according to the FSBM and the VSBM methods, the sums of errors between the present frame and the reference frame may be calculated for each block size within the search range, and an minimum sum of errors may be selected from the sums of errors. Here, the sum of errors is the same as that described in connection with the previous embodiment. Furthermore, N1, N2, . . . , NN candidate values greater than a minimum value are sequentially extracted within an error range set by a user on the basis of a block having a minimum value at which the sum of errors is a minimum, from among the blocks, and are stored in a T parameter. The N1, N2, . . . , NN candidate values are stored in order to search for an optimal block size having a compression rate better than the PSNR.

Next, the inter-prediction processing unit 207 (ME) extracts block prediction and motion vectors on the basis of a relevant block for each of the frames (S507). The inter-prediction processing unit 207 (MC) performs motion compensation (S508). Furthermore, after performing motion compensation, the inter-prediction processing unit 207 (MC) checks a PSNR value for each image type and stores the checked PSNR value in the database storage unit 212 as, for example, a P_Value (S509).

Next, the data processing unit 215 determines whether the PSNR of the relevant frame satisfies a preset value or N times (T=NN), that is, the number of times preset for the T value is satisfied or not (S510). If, as a result of the determination, both of the conditions are not satisfied, the T value is increased (S511), and the process returns to step S508 in which motion compensation is sequentially performed on the candidate values greater than the minimum sum of errors in order of N1, N2, . . . , NN. If, as a result of the determination, any one of the conditions is satisfied, the process proceeds to a next step (S512). As a result, motion compensation is sequentially and repeatedly performed based on each relevant block, while gradually increasing a relevant sum of errors of a block starting from a block having a minimum sum of errors.

If, as a result of the determination, the PSNR of the relevant frame is determined to satisfy the preset value or the T value satisfies the N times (T=NN), that is, a preset number of times, an image compression rate of the relevant frame is calculated (S512). That is, if a PSNR reference value is satisfied, a compression rate of the image is calculated through DCT, quantization, and entropy coding, and the calculated compression rate is stored in the B_Value parameter for each image type (S513).

Next, the data processing unit 215 determines whether the calculated image compression rate satisfies the threshold of the compression rate or not (S514). If, as a result of the determination, the image compression rate is determined not to satisfy the threshold of the compression rate, the setting management unit 205 reads and sets a block size and the number of partitions of each of blocks within a frame which are defined in a previously stored candidate list (S515), and the process returns to step S505 in which the partition task is performed according to new setting.

Meanwhile, if, as a result of the determination, the image compression rate is determined to satisfy the threshold of the compression rate, the data processing unit 215 requests a user to determine whether or not to change the block size and the number of partitions of the blocks within the frame (S516). If the user wants to change the block size and the number of partitions of the blocks within the frame, the block size and the number of partitions of the blocks within the frame are changed according to user selection (S517).

If the user does not want to change the block size and the number of partitions of the blocks within the frame, a final image type, determined based on the calculated PSNR value and the calculated compression rate, and setting parameters at this time are stored in the database storage unit 212 (S518). Here, the stored final image type may be classified into four image types as in listed in Table 1.

TABLE 1

| | PSNR | COMPRESSION RATE |
|---|---|---|
| Type1 | High | High |
| Type2 | Low | High |
| Type3 | High | Low |
| Type4 | Low | Low |

Next, the image analysis unit 202 checks the accuracy of an initial block size and an initial partition value according to the image type (S519) and checks and analyzes the influence of the initial block size and the initial partition value on the PSNR and the compression rate (S520). Finally, the image analysis unit 202 recommends a user to adjust a block size, a partition value, a threshold of the sum of errors, a threshold of the PSNR, and a threshold of the compression rate according to the image type on the basis of the analysis information and store the result of the adjustment in the database storage unit 212 (S521).

As described above, in accordance with the adaptive motion estimation method for an improved image compression rate according to the present embodiment, a task for searching for the best compression rate by applying motion compensation in various ways for each block size which has been set based on an image type may be performed, the four types of image data may be extracted by taking a compression rate and a PSNR value into consideration, and a correction task for searching for an optimal block size according to an image type may also be performed.

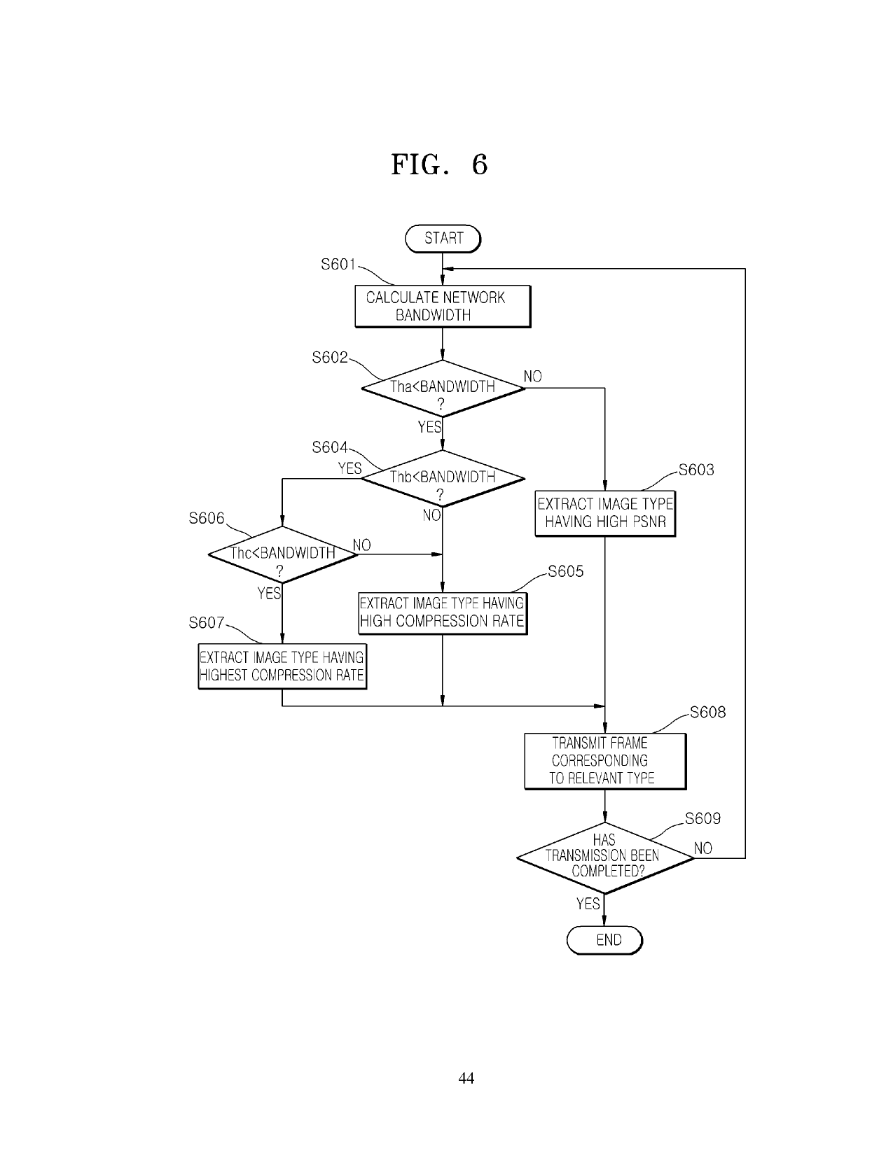

FIG. 6 is a flowchart illustrating a method of providing image data for each image type according to an embodiment of the present invention.

First, the resource management unit 214 calculates a network bandwidth provided to a client terminal (S601).

The resource management unit 214 primarily determines whether the network bandwidth exceeds a lower threshold Tha or not (S602). The lower threshold Tha, a higher threshold Thb, and the highest threshold Thc for the network bandwidth may be previously set according to user selection or an intention of a system designer. For example, assuming that a bandwidth is 100%, a value when the bandwidth exceeds 40% may be set as the lower threshold and stored in a Tha parameter, a value when the bandwidth exceeds 70% may be set as the higher threshold and stored in a Thb parameter, and a value when the bandwidth exceeds 90% may be set as the highest threshold and stored in a Thc parameter.

If, as a result of the primary determination, the network bandwidth is determined not to have exceeded the lower threshold Tha, the resource management unit 214 selects an image type having a high PSNR (S603). That is, if the network bandwidth has not exceeded the lower threshold Tha, it means that the network bandwidth has a good available state. Thus, Type 1 or 3 having a high PSNR, from among the four image types listed in Table 1, may be selected. It is a basic principle that frame transmission is performed using a service type having a high compression rate and the highest PSNR. If the image types 1 and 3 have a similar compression rate within an error range, frames are transmitted using a service type having a better PSNR, from among the image types 1 and 3.

Meanwhile, if, as a result of the primary determination at step S602, the network bandwidth is determined to have exceeded the lower threshold Tha, the resource management unit 214 secondarily determines whether the network bandwidth exceeds a higher threshold Thb or not (S604). If, as a result of the primary determination at step S604, the network bandwidth is determined to have exceeded the higher threshold Thb, it means that the network bandwidth has a poor available state and thus an image type having a high compression rate must be extracted from Table 1. Here, the image type 1 or 2 may be selected. An image type having the best compression rate, from among the image types 1 and 2, may be selected. If the image types 1 and 2 have a similar compression rate within an error range, however, frames may be transmitted by using a service type having a higher PSNR value, from among the image types 1 and 2.

If, as a result of the secondary determination at step S604, the network bandwidth is determined to have exceeded the higher threshold Thb, the resource management unit 214 thirdly determines whether the network bandwidth exceeds the preset highest threshold Thc (S606). If, as a result of the third determination at step S606, the network bandwidth is determined to have exceeded the highest threshold Thc, the resource management unit 214 selects an image type having the highest compression rate (S607).

If, as a result of the secondary determination at step S604, the network bandwidth is determined not to have exceeded the higher threshold Thb or if, as a result of the third determination the network bandwidth at step S608 is determined not to have exceeded the highest threshold Thc, the resource management unit 214 selects an image type having a compression rate lower than the image type at step S607, but higher than the image type at step S603 (S605).

Next, the data transmission unit 213 transmits a relevant frame corresponding to an image type selected at steps S603, S605, or S607 (S608).

Finally, the resource management unit 214 determines whether the transmission of data has been completed (S609). If, as a result of the determination, the transmission of data is determined not to have been completed, the process returns to step S601. If, as a result of the determination, the transmission of data is determined to have been completed, the process is terminated.

As described above, in accordance with the method of providing image data for each image type according to the present embodiment, network resources can be efficiently managed by flexibly selecting an image type according to an available network state and sending data corresponding to the selected image type.

In accordance with the pre-processing method according to the present invention, an image can be efficiently compressed according to an image type of the image. In accordance with the adaptive motion estimation method according to the present invention, an image compression rate can be improved by adaptively controlling a block size and the number of partitions according to an image type of an image. In accordance with the method of providing image data for each image type according to the present invention, a proper image type can be selected according to a network bandwidth through which an image is provided, and an image relevant to the selected image type can be transmitted.

The embodiments of the present invention have been disclosed above for illustrative purposes. Those skilled in the art will appreciate that various modifications, additions and substitutions are possible, without departing from the scope and spirit of the invention as disclosed in the accompanying claims.

What is claimed is:

1. An image compression pre-processing method before image compression, comprising:
extracting a plurality of sample frames from an image;
calculating a minimum value of sum of errors between each of blocks included in a random present sample frame of the sample frames and each of corresponding blocks of a reference sample frame;
generating an object for each region based on a distribution of the calculated minimum values of the sums of errors for each block;
calculating a motion reference value by tracking motion of the object in the plurality of sample frames; and
determining an image type of the image by comparing the motion reference value with a threshold.

2. The image compression pre-processing method of claim 1, further comprising setting a block size and a number of partitions for a plurality of frames included in the image based on the determined image type.

3. The image compression pre-processing method of claim 2, wherein in the setting of the block size and the number of partitions, the block size and the number of partitions are set for each object within a frame or the block size and the number of partitions are set for all the frames.

4. The image compression pre-processing method of claim 2, further comprising additionally setting a candidate list of a block size and a number of partitions for a plurality of frames included in the image.

5. The image compression pre-processing method of claim 1, further comprising:
reading a critical sum of errors for determining the image type; and
preliminarily determining an image type of the image by comparing the minimum value of the sum of errors, calculated from the random present sample frames, with the critical sum of errors.

6. The image compression pre-processing method of claim 1, wherein the sum of errors is a Sum of Square Errors (SSE) or a Sum of Absolute Errors (SAE) between pixel values at respective positions within each of the blocks of the present sample frame and pixel values at corresponding positions within a corresponding block of the reference sample frame.

7. An adaptive motion estimation method for an improved image compression rate, comprising:
performing intra-prediction on a relevant frame if the relevant frame is an I-frame;
reading a block size and a number of partitions of blocks within a frame according to a previously stored image type;
performing a partition task on the frame;
calculating a sum of errors between each of the blocks of the frame and each of blocks of a reference frame within a relevant search range;
extracting a prediction block and a motion vector;
sequentially and repeatedly performing motion compensation for each relevant block, while gradually increasing a relevant sum of errors starting from a block having a minimum sum of errors;
calculating an image compression rate of the frame;
determining whether the calculated image compression rate satisfies a threshold of a compression rate; and
if, as a result of the determination, the image compression rate is determined to satisfy the threshold of the compression rate, storing an image type of the relevant frame.

8. The adaptive motion estimation method of claim 7, wherein sequentially and repeatedly performing the motion compensation for the each relevant block is repeatedly performed until a Peak Signal-to-Noise Ratio (PSNR) of the relevant frame satisfies a preset value or until a preset number of times is reached.

9. The adaptive motion estimation method of claim 7, further comprising reading a block size and a number of partitions of blocks within a frame defined in a pre-stored candidate list and returning to the performing the partition task on the frame, if, as a result of the determination, the image compression rate is determined not to satisfy the threshold of the compression rate.

10. The adaptive motion estimation method of claim 7, further comprising newly reading a block size and a number of partitions of blocks within a frame changed according to user selection even though the image compression rate is determined to satisfy the threshold of the compression rate as a result of the determination, and returning to the performing the partition task on the frame.

11. The adaptive motion estimation method of claim 7, wherein the sum of errors is a Sum of Square Errors (SSE) or a Sum of Absolute Errors (SAE) between pixel values at respective positions within each of the blocks of the frame and pixel values at corresponding positions within a corresponding block of the reference frame.

12. A method of providing image data for each image type, comprising:
calculating a network bandwidth provided to a client terminal;
primarily determining whether the network bandwidth exceeds a lower threshold;
if, as a result of the primary determination, the network bandwidth is determined to exceed the lower threshold, secondarily determining whether the network bandwidth exceeds a higher threshold;
if, as a result of the secondary determination, the network bandwidth is determined to exceed the higher threshold, thirdly determining whether the network bandwidth exceeds a preset highest threshold;
if, as a result of the third determination, the network bandwidth is determined to exceed the highest threshold, selecting a first image type having a highest compression rate; and
transmitting a frame related to a selected image type.

13. The method of claim 13, further comprising selecting a second image type having a higher PSNR, if, as a result of the primary determination, the network bandwidth is determined not to exceed the lower threshold.

14. The method of claim 13, further comprising selecting a third image type having a compression rate lower than the first image type, but higher than the second image type, if, as a result of the secondary determination, the network bandwidth is determined not to exceed the higher threshold or if, as a result of the third determination, the network bandwidth is determined not to exceed the highest threshold.
